(19) United States
(12) Patent Application Publication
(10) Pub. No.: US 2014/0192523 A1
(43) Pub. Date: Jul. 10, 2014

(54) Flashlight Tamper-Proof Structure

(71) Applicant: Shih-Hao Wang, Tainan City (TW)

(72) Inventor: Shih-Hao Wang, Tainan City (TW)

(21) Appl. No.: 13/733,949

(22) Filed: Jan. 4, 2013

(51) Int. Cl. F21L 4/00

(52) U.S. Cl. CPC F21L 4/00
USPC 362/202

(57) ABSTRACT

A flashlight tamper-proof structure for preventing a lamp cover fastened to an end of a flashlight from being unfastened manually is characterized in that: an appropriate section of an opening of a body of the flashlight forms a dented area having an internally threaded hole; an end of an opening of the lamp cover extends to form a carrying section, such that a connection element fits tightly inside the carrying section; an end of the connection element extends to form a rod section; a protruding portion having an inward-penetrating hole is formed at an end of the rod section, such that the protruding portion at the end of the rod section is positioned at the dented area on one side of the body; afterward, a screw is inserted into the hole at the end of the rod section and screwed to the internally threaded hole of the dented area.

### BACKGROUND OF THE INVENTION

1. Technical Field

The present invention provides a flashlight tamper-proof structure characterized in that: an appropriate section of an opening of a body of a flashlight capable of illumination forms a dented area having an internally threaded hole; a connection element tightly engaged with an end of an opening of a lamp cover extends to form a rod section corresponding in position to and straddlingly disposed at the dented area of the body; and a screw is inserted into the hole at an end of the rod section of the connection element and screwed to the internally threaded hole of the dented area. Accordingly, the lamp cover fastened to an end of the flashlight cannot be unfastened manually.

2. Description of Related Art

A conventional flashlight capable of illumination has to meet a safety standard (UL): a lamp cover of the flashlight cannot be manually unfastened but can only be unfastened with a tool. To this end, related manufacturers put forth a flashlight characterized in that the flashlight essentially comprises a flashlight body and a lamp cover which are tightly engaged with each other when put together or are integrally formed as a unitary structure, such that a user needs a tool to separate the flashlight body and the lamp cover in order to change a light bulb therein or has to dismount from or mount on the other end of the flashlight body an object.

Therefore, it is imperative to provide a flashlight tamper-proof structure for preventing a lamp cover from being unfastened without a tool.

### SUMMARY OF THE INVENTION

The present invention provides a flashlight tamper-proof structure for preventing a lamp cover fastened to a front end of an illumination-oriented flashlight from being unfastened manually. The flashlight tamper-proof structure is characterized in that: an appropriate section of an opening of a body of a flashlight forms a dented area having an internally threaded hole; a connection element tightly engaged with an end of an opening of a lamp cover extends to form a rod section corresponding in position to and straddlingly disposed at the dented area of the body; and a screw penetrates the hole at an end of the rod section of the connection element and is screwed to the internally threaded hole of the dented area. Accordingly, the lamp cover fastened to an end of the flashlight cannot be unfastened manually.

The first objective of the present invention is to provide a flashlight tamper-proof structure characterized in that: a lamp cover fastened to an end of a flashlight cannot be unfastened manually; a dented area having an internally threaded hole is defined in an appropriate section of a body of the flashlight, wherein the dented area is positioned proximate to an opening of the body; an end of an opening of the lamp cover extends to form a carrying section, such that a connection element is fitted tightly inside and engaged with an outer periphery of the carrying section; an end of the connection element extends to form a rod section; a protruding portion having an inward-penetrating hole is formed at an end of the rod section, such that the protruding portion at the end of the rod section of the connection element is positioned at the dented area on one side of the body; afterward, a screw is inserted into the hole at the end of the rod section and screwed to the internally threaded hole of the dented area. Accordingly, the lamp cover fastened to an end of the flashlight cannot be unfastened manually.

The second objective of the present invention is to provide a flashlight tamper-proof structure characterized in that the outer diameter of the carrying section formed by extending the end of the opening of the lamp cover has to be slightly larger than the inner diameter of the connection element fitted inside the carrying section, such that the connection element and the carrying section at the end of the lamp cover are tightly positioned in place.

The third objective of the present invention is to provide a flashlight tamper-proof structure characterized in that, after removing the screw otherwise screwed to the rod section positioned at the dented area on one side of the body, the connection element tightly engaged with an end of the opening of the lamp cover is removed from the body together with the lamp cover to render it easy to change a power-supplying battery of the flashlight.

### BRIEF DESCRIPTION OF THE SEVERAL VIEWS OF THE DRAWINGS

FIG. 1 is an exploded view of the flashlight tamper-proof structure according to the present invention;

FIG. 2 is a schematic view of assembly and operation of the flashlight tamper-proof structure according to the present invention; and

FIG. 3 is a schematic view of the flashlight tamper-proof structure in an unfastening mode according to the present invention.

### DETAILED DESCRIPTION OF THE EMBODIMENT OF THE INVENTION

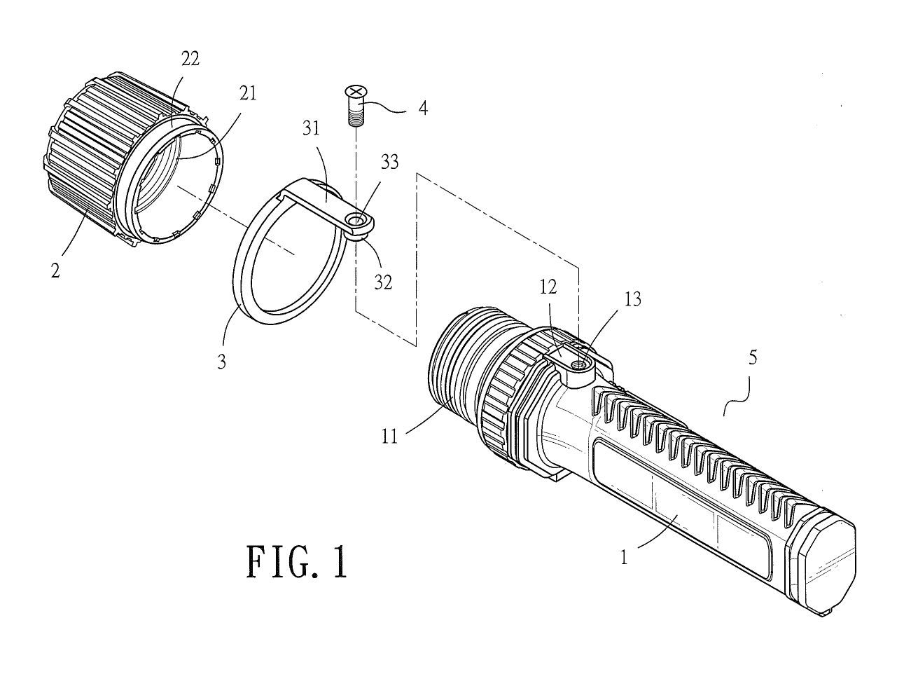

Referring to FIG. 1, the present invention provides a flashlight tamper-proof structure for preventing a lamp cover 2 fastened to an end of an opening of a body 1 of a flashlight 5 from being unfastened manually. The flashlight tamper-proof structure essentially comprises the body 1, the lamp cover 2, and a connection element 3.

The body 1 has therein a space for receiving a power-supplying battery. An end of the opening of the body 1 extends to form an external thread section 11 for use in fastening the lamp cover 2. A dented area 12 having an internally threaded hole 13 is defined in an appropriate section of the body 1, wherein the dented area 12 is positioned proximate to the opening of the body 1.

The coverage of the flashlight lamp by the lamp cover 2 depends on the external thread section 11 extending from an end of the opening of the body 1. An internal thread section 21 is formed inside the lamp cover 2. An end of an opening of the lamp cover 2 extends to form a carrying section 22 (wherein the internal thread section 21 and the carrying section 22 at the end of the opening of the lamp cover 2 can be implemented together in the form of an element, such that the element and the lamp cover 2 are integrally formed as a unitary structure by bagging.) The outer diameter of the carrying section 22 formed by extending the end of the opening of the lamp cover 2 has to be slightly larger than the inner diameter of the connection element 3 fitted inside the carrying section 22, such that the connection element 3 and the carrying section 22 at the end of the lamp cover 2 are tightly positioned in place.

The connection element 3 is a checking element that depends on the lamp cover 2 and the end of the opening of the body 1. A rod section 31 extends from one side of the connection element 3. A protruding portion 32 which is penetrated by a hole 33 is inwardly formed at the end of the rod section 31 (wherein the protruding portion depends on the dented area 12 on one side of the body 1).

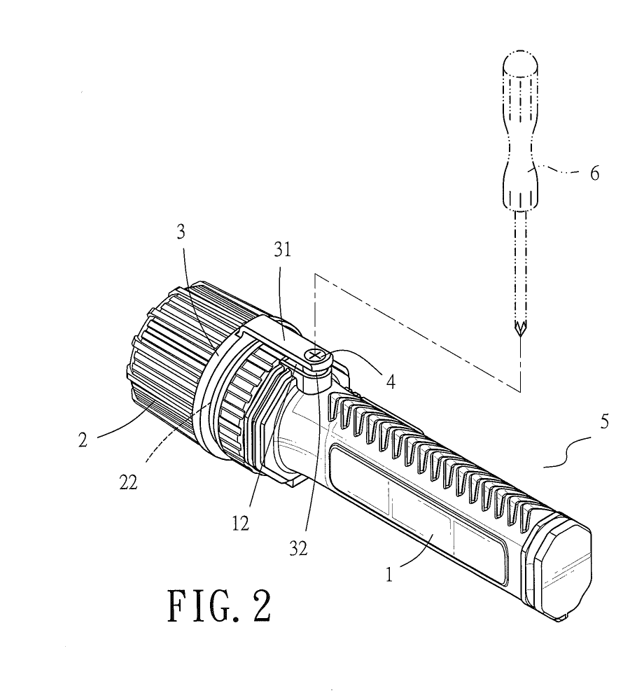

Referring to FIG. 1 and FIG. 2, there are shown diagrams of the fastening together of the body 1, the lamp cover 2, and the connection element 3. Step 1: fitting the connection element 3 tightly inside the carrying section 22 extended from the end of the opening of the lamp cover 2. Step 2: screwing the lamp cover 2 to the external thread section 11 at an end of the opening of the body 1, such that the rod section 31 extending from the connection element 3 engaged with and disposed at the end of the opening of the lamp cover 2 is straddlingly disposed at the dented area 12 of the body 1, and the protruding portion 32 at the end of the rod section 31 corresponds in position to the internally threaded hole 13 of the dented area 12. Step 3: guiding, with a tool 6 (provided in the form of a screwdriver), a screw 4 into the hole 33 at the end of the rod section 31, and screwing the screw 4 to the internally threaded hole 13 of the dented area 12, such that the lamp cover 2 screwed to an end of the body 1 of the flashlight 5 cannot be unfastened manually because of the position-limiting effect of the connection element 3.

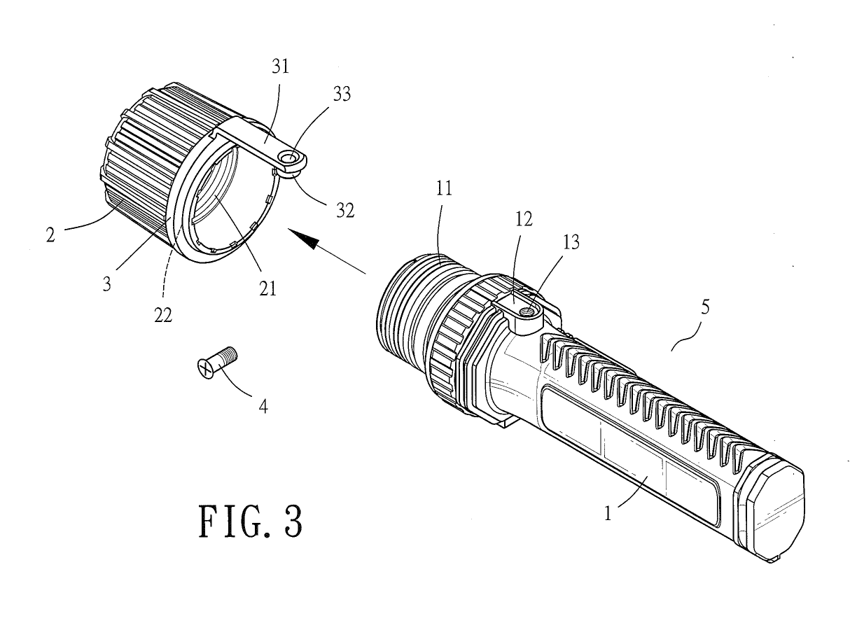

Unfastening the lamp cover 2 which is otherwise screwed to an end of the opening of the body 1 of the flashlight 5 entails: loosening and removing, with the tool 6, the screw 4 otherwise screwed to the rod section 31 on one side of the connection element 3 and the internally threaded hole 13 of the body 1 (as shown in FIG. 3, such that the connection element 3 tightly engaged with the end of the opening of the lamp cover 2 and the lamp cover 2 together are removed from the external thread section 11 of the body 1 of flashlight 5 to render it easy to change a power-supplying battery of the flashlight 5. Accordingly, the flashlight tamper-proof structure meets a flashlight product safety standard (UL): a lamp cover of a flashlight cannot be unfastened without a tool.

What is claimed is:

1. A flashlight tamper-proof structure for preventing a lamp cover fastened to an end of a flashlight from being unfastened manually, characterized in that: a dented area having an internally threaded hole is defined in an appropriate section of a body of the flashlight, wherein the dented area is positioned proximate to an opening of the body; an end of an opening of the lamp cover extends to form a carrying section, such that a connection element is fitted tightly inside and engaged with an outer periphery of the carrying section; an end of the connection element extends to form a rod section; a protruding portion having an inward-penetrating hole is formed at an end of the rod section, such that the protruding portion at the end of the rod section of the connection element is positioned at the dented area on one side of the body; and a screw is inserted into the hole at the end of the rod section and screwed to the internally threaded hole of the dented area, thereby preventing the lamp cover fastened to an end of the flashlight from being unfastened manually.

2. The flashlight tamper-proof structure of claim 1, wherein an outer diameter of the carrying section formed by extending the end of the opening of the lamp cover has to be slightly larger than an inner diameter of the connection element fitted inside the carrying section, such that the connection element and the carrying section at the end of the lamp cover are tightly positioned in place.

3. The flashlight tamper-proof structure of claim 1, wherein, after removing the screw otherwise screwed to the rod section positioned at the dented area on one side of the body, the connection element tightly engaged with an end of the opening of the lamp cover is removed from the body together with the lamp cover to render it easy to change a power-supplying battery of the flashlight.
